(19) United States
(12) Patent Application Publication
(10) Pub. No.: US 2016/0063564 A1
(43) Pub. Date: Mar. 3, 2016

(54) SYSTEM AND METHOD FOR OFFERING A WARRANTY OVER A DISTRIBUTED DATA NETWORK

(71) Applicants: David Ward, Abbotsford (CA); Richard Hui, Coquitlam (CA)

(72) Inventors: David Ward, Abbotsford (CA); Richard Hui, Coquitlam (CA)

(21) Appl. No.: 14/475,537

(22) Filed: Sep. 2, 2014

(51) Int. Cl. G06Q 30/02; G06Q 20/20

(52) U.S. Cl. CPC G06Q 30/0268; G06Q 20/202

(57) ABSTRACT

An automated system for making an offer over a distributed data network comprises a first processor and a second processor in communication over the distributed data network. The first processor receives purchase information related to a purchase being made by a consumer. There is an offer engine on the second processor. The offer engine associates the goods and services available for purchase by the consumer with a warranty and additional goods and services. A computer program executed by the first processor triggers the offer engine to make an offer to the consumer based on the goods and services being purchased when the purchase is being made by the consumer

### BACKGROUND OF THE INVENTION

1. Field of the Invention

The present invention relates to a system for making an offer to a consumer and, in particular, to a system for making an offer to a consumer over a distributed data network at a point-of-sale.

2. Description of the Related Art

United States Patent Application Publication Number 2001/00442022 which was published on Nov. 15, 2001 in the name of Kirkpatrick et al. discloses systems and methods that allow retail entities to let consumers register a product or warranty at a point-of-sale. The systems and methods allow a retailer to identify a point during a purchasing transaction wherein the consumer has completed a transaction. The retailer may then present to the consumer an interface that the consumer may easily complete to allow the consumer to participate in a product or warranty registration process. The systems and methods make the product registration process part of the purchase transaction and therefore make the product registration process seamless and more facile. Consequently it is understood that consumer participation within the product registration process increases.

United States Patent Application Publication Number 2002/0128851 which was published on Sep. 12, 2002 in the name of Chefalas et al. discloses systems and methods for automating product registration of one or more products by transmitting product registration information generated at the time of purchase respectively to one or more manufacturers for subsequent completion of the registration of the one or more products automatically by the one or more manufacturers or by the customer.

There is however a need for automated systems and methods to allow a third party warranty provider to offer a warranty at a point-of-sale and allow a third party to offer additional goods and services at the point-of-sale.

### SUMMARY OF THE INVENTION

There is provided an automated system for offering a warranty over a distributed data network. The system comprises a first processor and a second processor in communication over the distributed data network. The first processor receives purchase information related to a purchase being made by a consumer. There is an offer engine on the second processor. The offer engine associates the goods and services available for purchase by the consumer with a warranty. A computer program executed by the first processor triggers the offer engine to offer the consumer a warranty based on the goods and services being purchased when the purchase is being made by the consumer.

The first processor may be part of an e-commerce store and the computer program may be a code inserted into a webpage of the e-commerce store. The first processor may be part of a point-of-sale system for a brick and mortar store. There may be a database on the second processor which contains the goods and services available for purchase by the consumer and the warranty associated with each of the goods and services available for purchase by the consumer. There may be a categorization engine on the second processor which categorizes the goods and services available for purchase by the consumer to allow the offer engine to associate the goods and services available for purchase by the consumer with the warranty.

There is also provided an automated system for offering additional goods and services over a distributed data network. The system comprises a first processor and a second processor in communication over the distributed data network. The first processor receives purchase information related to a purchase being made by a consumer. There is an offer engine on the second processor. The offer engine associates the goods and services available for purchase by the consumer with additional goods and services. A computer program executed by the first processor triggers the offer engine to offer the consumer additional goods and services based on the goods and services being purchased when the purchase is being made by the consumer.

The first processor may be part of an e-commerce store and the computer program may be a code inserted into a webpage of the e-commerce store. The first processor may be part of a point-of-sale system for a brick and mortar store. There may be a database on the second processor which contains the goods and services available for purchase by the consumer and the additional goods and services associated with each of the goods and services available for purchase by the consumer. There may be a categorization engine on the second processor which categorizes the goods and services available for purchase by the consumer to allow the offer engine to associate the goods and services available for purchase by the consumer with the additional goods and services.

There is further provided a method of making an offer over a distributed data network. The method comprises:
providing a first processor which receives purchase information related to a purchase being made by a consumer;
providing a second processor with an offer engine which associates goods and services available for purchase by the consumer with an offer;
placing the first processor and the second processor in communication over the distributed data network; and
executing a computer program on the first processor to trigger the offer engine to make the consumer an offer based on the goods and services being purchased when the purchase is being made by the consumer.

The method may further include categorizing the goods and services available for purchase by a consumer and associating the goods and services available for purchase by a consumer with an offer. The method may further include modifying the offer if the offer is rejected by the consumer. The method may further include following up with the consumer if the consumer rejects the offer. The method may further include providing text or ranked text to encourage the consumer to accept the offer. Making the consumer the offer may include offering the consumer a warranty. Modifying the offer if the offer is rejected by the consumer may include offering another warranty. Making the consumer the offer may include offering the consumer additional goods and services.

### BRIEF DESCRIPTION OF DRAWINGS

The invention will be more readily understood from the following description of embodiments thereof given, by way of example only, with reference to the accompanying drawings, in which:

FIG. 1 is a schematic illustrating a distributed data processing system in which an improved system for a third party warranty provider to offer a warranty at a point-of-sale may be implemented;

FIG. 2 is a schematic illustrating architecture of a processor of the data processing system of FIG. 1;

FIG. 3 is a flow chart of the logic of the system for offering a warranty when a purchase is made at an e-commerce store;

FIG. 4 is a screenshot of an e-commerce website showing a warranty being offered when a purchase is made at an e-commerce store;

FIG. 5 is a screenshot of an e-commerce website showing the warranty being accepted when a purchase is made at an e-commerce store;

FIG. 6 is a screenshot of an e-commerce website showing additional goods and services being offered when a purchase is made at an e-commerce store;

FIG. 7 is a flow chart of the logic of the system for a third party warranty provider to offer a warranty when purchase orders are being fulfilled;

FIG. 8 is a flow chart of the logic of the system for a third party warranty provider to offer a warranty when a personalized offer is being made; and

FIG. 9 is a schematic showing different platforms on which the system for a third party warranty provider to offer a warranty may be deployed.

### DESCRIPTION OF THE PREFERRED EMBODIMENTS

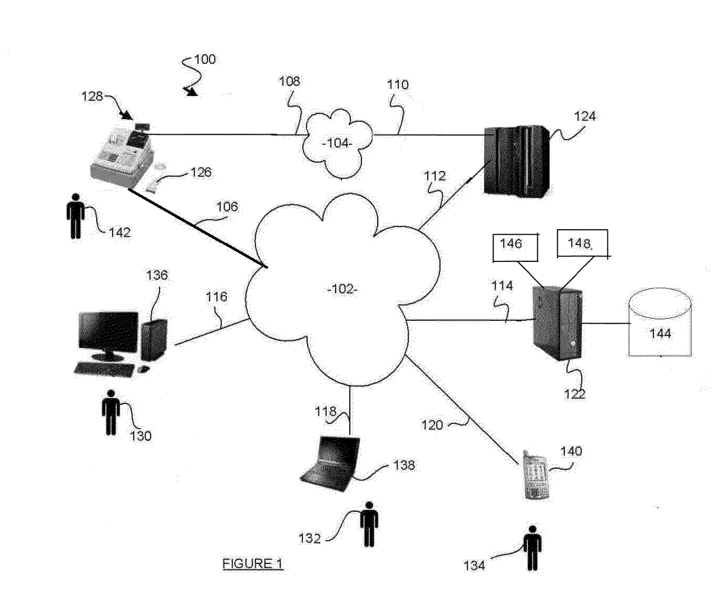

Referring to the drawings and first to FIG. 1 this shows a distributed data processing system 100. The distributed data processing system 100 is given by way of example only, and is typical of a data processing system in which an improved system for offering a warranty may be implemented. The data processing system 100 includes networks 102 and 104 which provide communication links between various processors. The communication links may be permanent connections including, but not limited to, wires 106, 108 and 110 or fiber optic cables 112 and 114. The communication links may also be temporary connections including, but not limited to, connections made through telephone 116 or wireless communication 118 and 120. In the data processing system 100 one of the networks 102 is the Internet and the other one of the networks is an intranet such as a wide area network (WAN) or a local area network (LAN). It will be understood by a person skilled in the art that the data processing system 100 may further include additional networks and various different types of networks which have not been shown.

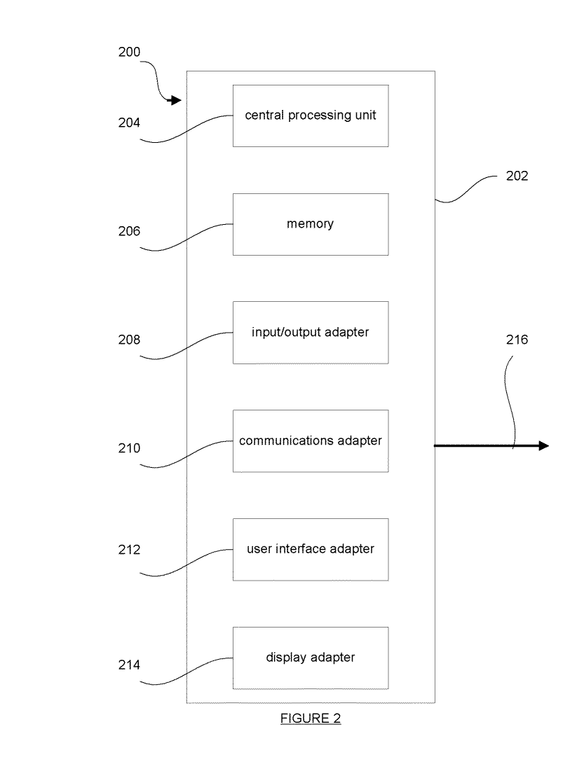

The data processing system 100 further includes a plurality of processors. FIG. 2 illustrates an exemplary architecture 200 of a processor in the data processing system 100. An internal bus system 202 interconnects a central processing unit (CPU) 204 with a memory 206, an input/output adapter 208, a communications adapter 210, a user interface adapter 212, and a display adapter 214. The memory 206 may include one or more types of random access memory (RAM) and read only memory (ROM). The memory 206 may also include one or more types of volatile and non-volatile memory. The input/output adapter 208 may support various input/output devices including, but not limited to, a disk unit, a printer, and a scanner. The communications adapter 210 may provide access to a communication link 216 such as a fiber optic cable which may connect the CPU 204 to the data processing system 100 of FIG. 1. The user interface adapter 212 may support various user interface devices, including but not limited to, a touch screen, a keyboard, and a mouse. The display adapter 214 may support various display devices such as a monitor. FIG. 2 is provided by way of example only and is in no way intended to imply architectural limitations to any processor in the distributed data processing system 100 of FIG. 1. Furthermore, it will be understood by a person skilled in the art that the hardware of FIG. 2 may vary between processors.

Furthermore, in addition to being implemented on a variety of hardware platforms, the warranty management system may also be implemented on a variety of software platforms, i.e. the operating system used may vary between processors. For example, a server may run on a Linux® operating system, while a mainframe computer runs on an IBM z/OS® operating system and desktop computer runs on a Microsoft® operating system. Other processors in the data processing system 100 may run on other operating systems. The processors in the data processing system 100 may further support a typical browser application or another suitable application for retrieving HTTP documents in a variety of formats. It will be understood by a person skilled in the art that the data processing system 100 may further include additional processors and various different types of processors which have not been shown.

Referring back to FIG. 1, in this example, the data processing system 100 includes a server 122 and a mainframe computer 124. The server 122 is a database server running MongoDB® in this example. The mainframe computer 124 supports an e-commerce store. There is also a barcode or Universal Product Code (UPC) scanner 126 which is part of a brick and mortar store point-of-sale (POS) system 128 associated with the e-commerce store. Consumers 130, 132 and 134 may connect to the data processing system 100 and make online purchases at the e-commerce store using a processor such as a desktop computer 136, a laptop computer 138 or a smart phone 140. A consumer 142 may also be connected to the data processing system 100 when making a purchase using the brick and mortar store point-of-sale (POS) system 128.

There is a database 144 on the server 122. The database 144 contains a list of goods and services offered by a merchant which are categorized by a categorization engine 146. The database 144 may be populated by uploading or downloading a merchant database or manually inputting data. The goods and services may be categorized by algorithms or a manual filter process. The categorization engine 146 will also learn from mistakes as feedback is identified from corrections. This continuous learning process will improve categorization of the goods and services. An offer engine 148 supported by the server 122 cross-references the database 144 to determine an appropriate warranty to offer to a consumer based on the goods and services being purchased as will be described below.

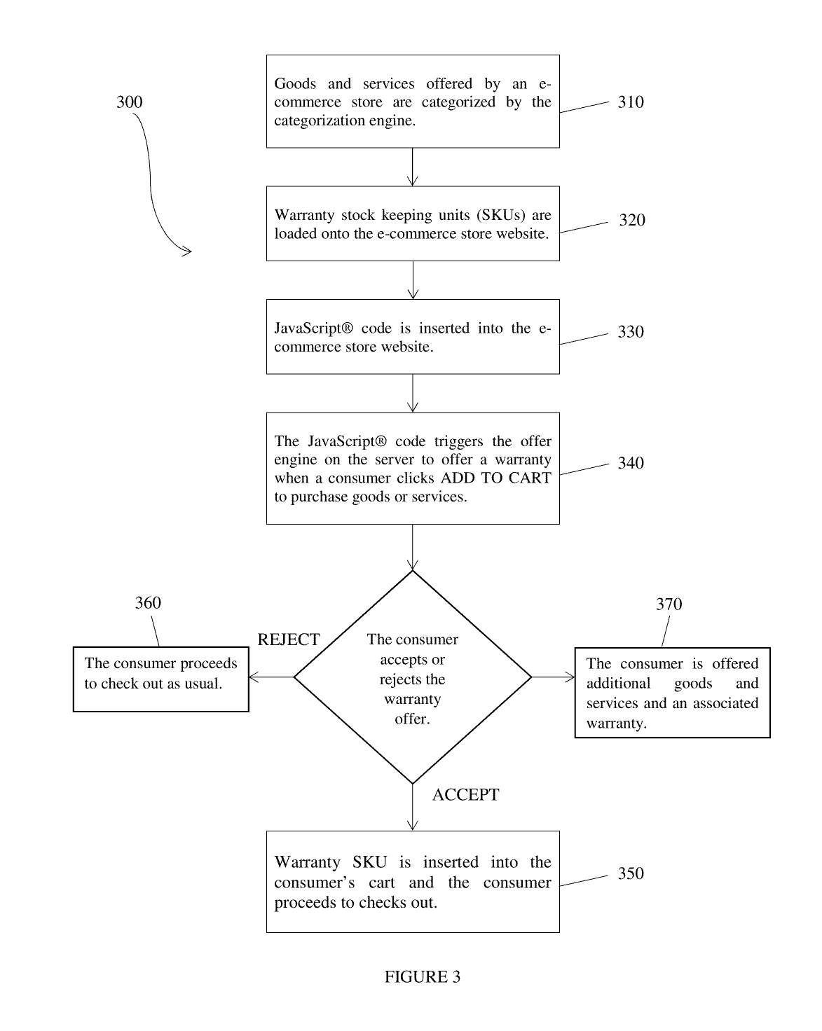

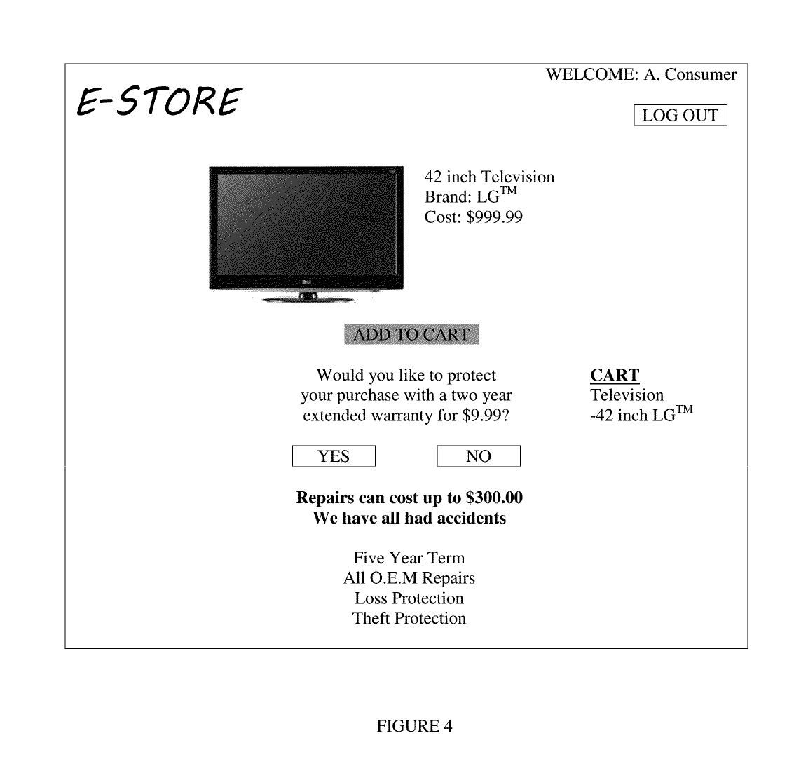

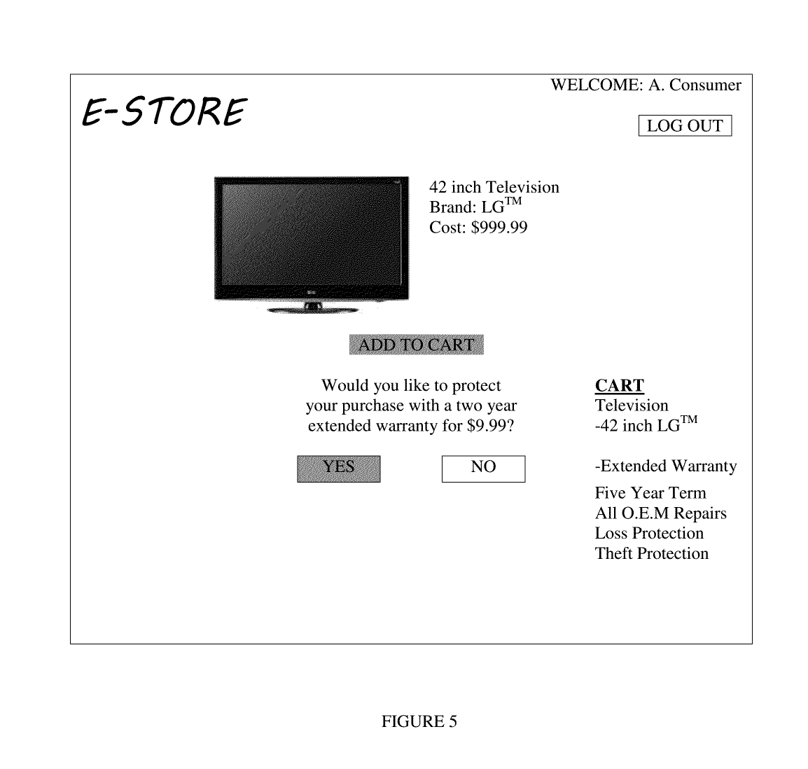

FIG. 3 shows a flow diagram of the logic of a system 300 when a purchase is made at an e-commerce store. The goods and services offered by the e-commerce store are categorized by the categorization engine 146 at step 310 or may alternatively be categorized in real time. Warranty stock keeping units (SKUs) are loaded onto the e-commerce store website at step 320 and a computer program in the form of JavaScript® code is inserted into the e-commerce store website at step 330. The JavaScript® code triggers the offer engine 148 on the server 122 to offer a warranty when a consumer clicks an icon, for example, ADD TO CART, to purchase goods or services at step 340. In other examples however the JavaScript® code could be developed with code for the e-commerce store and pull data from the server 122. The warranty offer appears on the e-commerce store website, as shown in FIG. 4, despite the warranty offer being made by a third party warranty provider and not a merchant operating the e-commerce store. If the consumer accepts the warranty offer then the warranty SKU is inserted into the consumer's cart, as shown in FIG. 5, before the consumer proceeds to check out at step 350 in FIG. 3. If the consumer declines the warranty offer then the consumer proceeds to check out as usual at step 360 in FIG. 3. The entire transaction occurs on the website of the e-commerce store. In other examples, the categorization engine 146 may categorize the goods or services being purchased at the time of purchase and the offer engine may offer a warranty after a plurality of goods and/or services have been added to the consumer's cast and the consumer clicks an icon, for example, CHECKOUT, to purchases the plurality of goods and/or services.

The offer engine 148 offers a warranty based on the categorization of the goods and services being purchased. The warranty offer may be based on a price range or selling price of the goods and services being purchased. The offer engine may provide details related to the term and coverage as shown in FIGS. 4 to 6. The offer engine may further provide text to encourage the consumer to purchase a warranty. An example of such text is shown in FIG. 4 and is visibly displayed on a webpage for the consumer to read. The text provided is determined using A/B testing to determine text that successfully encourages the consumer to purchase the warranty.

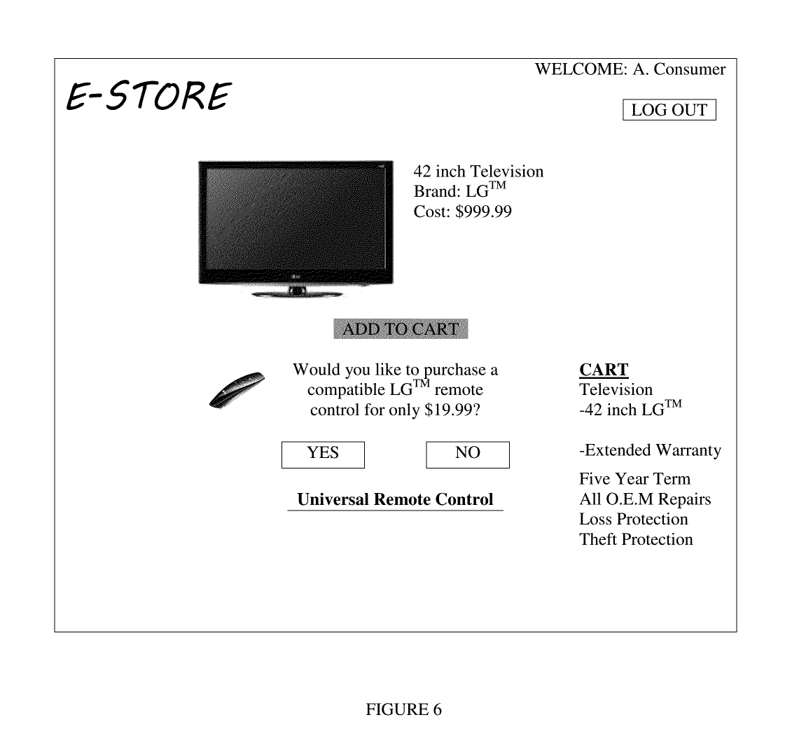

The offer engine 148 may offer a warranty based on analysis of consumer purchasing habits based on data related to previous purchases, data collected on e-commerce websites, aggregate data on consumer behaviour, and consumer demographics. The offer engine 148 may base analytics on consumer based recommendations, order based recommendations, and product-warranty pair based recommendations. Furthermore, in addition to offering a warranty, the offer engine 148 may offer additional goods and services based on the characterization of the goods and services being purchased. This is shown at step 370 in FIG. 1 and FIG. 6. The additional goods and services offered complement the goods and services being purchased based on associations made by the categorization engine 146. The system may deploy cookies or other tracking tools to track consumer behaviour on e-commerce websites. This information can be analyzed to improve offers made to individual consumers by the offer engine 148 or provide aggregate data to improve general offers made by the offer engine 148. The offer engine is thereby able to learn to associate a specific warranty with a specific good or service. The offer engine may further provide text to encourage the consumer to purchase the additional goods and services. An example of such text is shown in FIG. 6 and is visibly displayed on a webpage for the consumer read. The text provided is determined using A/B testing to determine text that successfully encourages the consumer to purchase the additional goods and services.

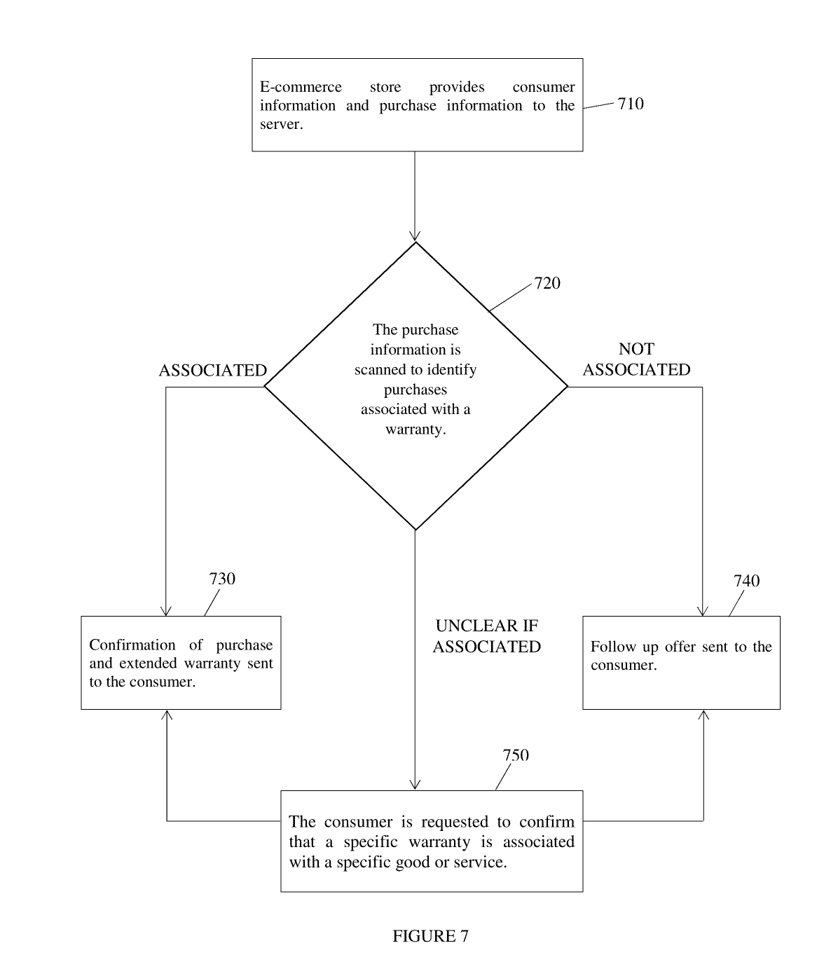

The system may also assist the e-commerce store with purchase order fulfillment as shown in FIG. 7. The mainframe computer 124 of the e-commerce store provides consumer information and purchase information to the server 122 at step 710. The purchase information is scanned to identify purchases associated with an extended warranty at step 720. If a purchase is associated with an extended warranty then a confirmation will be sent to the consumer at step 730. The association of an extended warranty with a purchase may also trigger further actions including, but not limited to, preparation for claims, the setting up of a consumer account, the billing of the e-commerce store, order execution with a warranty provider, and the tracking of the extended warranty and any manufacturer warranty. If the purchase is not associated with a warranty then a follow-up offer may be sent to the consumer at step 740. The lack of an association of an extended warranty with a purchase may also trigger further actions including, but not limited to, the setting up of a consumer account, the tracking of purchases, and analysis of the purchase information by the offer engine 148.

There may be instances in which it is unclear which warranty should be associated with a specific good or service in the purchase information. This is because a warranty may apply to multiple goods and services in the purchase information. The system therefore tracks and identifies specific warranties associated with specific goods and services as described above. If however the warranty cannot be associated with a specific good or service then a confirmation pop-up is presented to the consumer to confirm the warranty association at step 750. Alternatively, a follow-up with the consumer can be employed to prompt the consumer to associate the warranty with a specific good or service.

Referring back to FIG. 1, the system may also be employed when a purchase is made at a brick and mortar store. The goods and services offered by the bricks and mortar store are first categorized by the categorization engine 146. Warranty stock keeping units (SKUs) are loaded onto and a code inserted into the software of the brick and mortar store point-of-sale (POS) system 128. When a purchase is entered into the brick and mortar store point-of-sale (POS) system 128 by, for example, scanning a barcode with the Universal Product Code (UPC) scanner 126 then the code triggers the offer engine 148 to offer a warranty or additional goods or services at the point-of-sale. The consumer may then accept or decline the warranty offer or additional goods and services offer. The offer engine 148 may send a merchant text to use to encourage the consumer to purchase a warranty or additional goods and services. The text provided is determined using A/B testing to determine text that successfully encourages the consumer to purchase the warranty or additional goods and services. The merchant may be provided with text in the form of phrases that are ranked based on rates of success for encouraging the consumer to purchase the warranty or additional goods and services. Examples of phrases ranked in descending order are shown below.

1. Everyone has accidents and repairs can be expensive.

2. The cost of the warranty works out to a couple cents a day.

3. A warranty provides peace of mind.

The merchant may then select the text to use based on the ranking and perceived needs of the consumer.

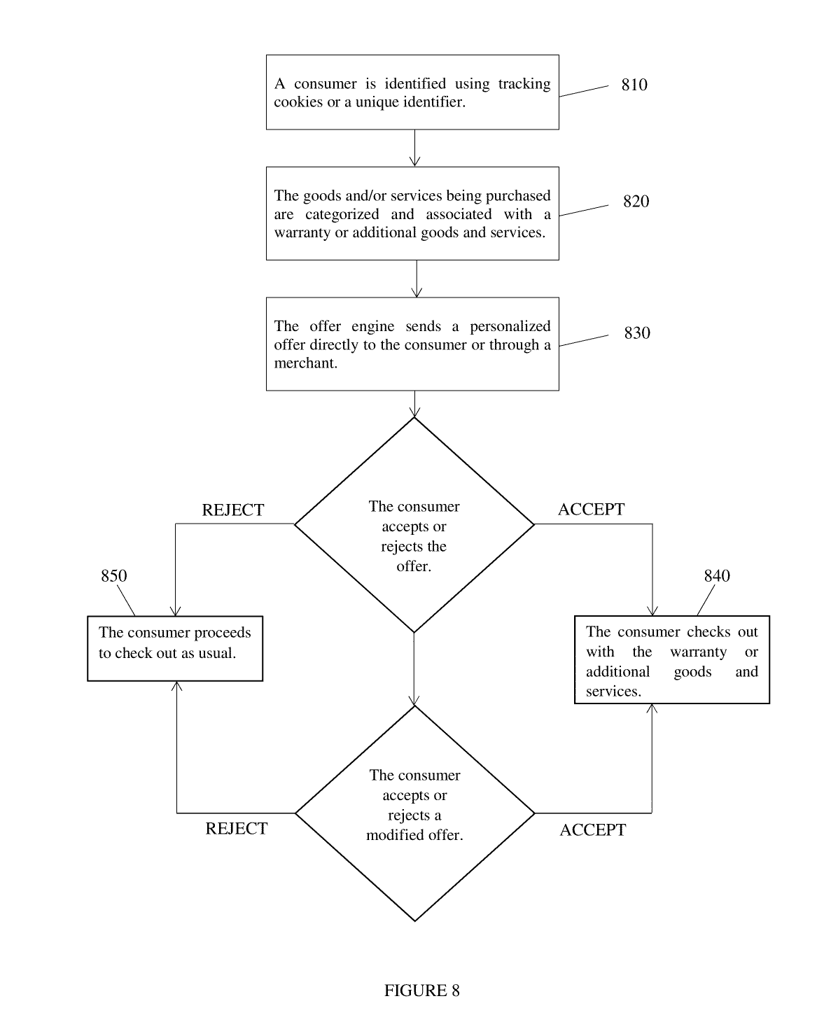

The system may personalize an offer as shown in FIG. 8. A consumer is identified by a tracking cookie or unique identifier such as an email address, telephone number, or user name at step 810. The goods and/or services being purchased by the consumer are then categorized and associated with a warranty or additional goods and services at step 820. The offer engine may offer a warranty or additional goods and services directly to the consumer or through a merchant at step 830. The personalized offer is generated based on analysis of the consumer's history by the offer engine 148. If the consumer accepts the offer then the consumer proceeds to check out with the warranty or additional goods and services at step 840. If the consumer declines the offer then the consumer proceeds to check out as usual at step 850. The warranty may also be modified based on input from the consumer. The consumer is then able to accept or reject the modified offer.

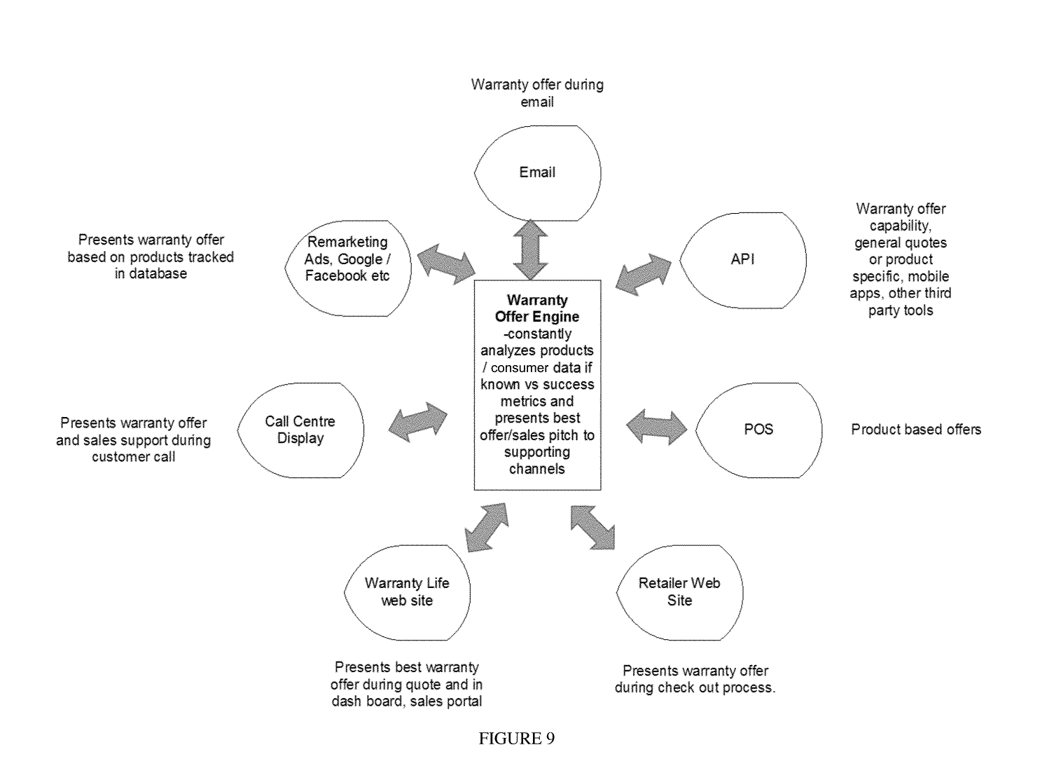

The system may further be employed in other applications as shown in FIG. 9. In addition to making offers on a retailer website (i.e. an e-commerce store) and at the point-of-sale (POS) at a brick and mortar store, the offer engine 148 may offer a warranty or additional goods and services at the website of a warranty provider. The offer engine may also offer a warranty or additional goods and services on a call center display, on remarketing advertisements on social media, direct to consumers by email, and on an application programming interface (API). The offer engine 148 may also access third party databases.

It will be understood by a person skilled in the art that many of the details provided above are by way of example only, and are not intended to limit the scope of the invention which is to be determined with reference to the following claims.

What is claimed is:

1. An automated system for offering a warranty over a distributed data network, the system comprising:
a first processor which receives purchase information related to a purchase being made by a consumer;
a second processor in communication with the first processor over the distributed data network;
an offer engine on the second processor which associates goods and services available for purchase by the consumer with a warranty; and
a computer program executed by the first processor to trigger the offer engine to offer the consumer a warranty based on the goods and services being purchased when the purchase is being made by the consumer.

2. The automated system as claimed in claim 1 wherein the first processor is part of an e-commerce store and the computer program is a code inserted into a webpage of the e-commerce store.

3. The automated system as claimed in claim 1 wherein the first processor is part of a point-of-sale system for a brick and mortar store.

4. The automated system as claimed in claim 1 further including a database on the second processor which contains the goods and services available for purchase by the consumer and the warranty associated with each of the goods and services available for purchase by the consumer.

5. The automated system as claimed in claim 4 further including a categorization engine on the second processor which categorizes the goods and services available for purchase by the consumer to allow the offer engine to associate the goods and services available for purchase by the consumer with the warranty

6. A method of offering a warranty over a distributed data network, the method comprising:
providing a first processor which receives purchase information related to a purchase being made by a consumer;
providing a second processor with an offer engine which associates goods and services available for purchase by the consumer with a warranty;
placing the first processor and the second processor in communication over the distributed data network; and
executing a computer program on the first processor to trigger the offer engine to offer the consumer the warranty based on the goods and services being purchased when the purchase is being made by the consumer.

7. The method as claimed in claim 6 further including categorizing the goods and services available for purchase by the consumer and associating the goods and services available for purchase by the consumer with the warranty.

8. The method as claimed in claim 6 further including offering another warranty if the warranty is rejected by the consumer.

9. The method as claimed in claim 6 further including following up with the consumer if the consumer rejects the warranty.

10. The method as claimed in claim 6 further including offering the consumer additional goods and services with the warranty.

11. The method as claimed in claim 6 further including providing text to encourage the consumer to accept the warranty.

12. The method as claimed in claim 6 further including providing ranked text to encourage the consumer to accept the warranty.
